(19) United States
(12) Patent Application Publication
(10) Pub. No.: US 2011/0052100 A1
(43) Pub. Date: Mar. 3, 2011

(54) INTEGRAL CLOSURE SYSTEM FOR A FLEXIBLE BAG

(75) Inventors: Mikel Eisenberg, New York, NY (US); Kristen Brown, Murrells Inlet, SC (US)

(73) Assignee: The Waste Solutions, LLC, Rockville Center, NY (US)

(21) Appl. No.: 12/551,769

(22) Filed: Sep. 1, 2009

(51) Int. Cl. B65D 33/06; B31B 1/90; B65D 33/16

(52) U.S. Cl. 383/12; 493/214; 383/77

(57) ABSTRACT

A closure system for a flexible bag. The flexible bag includes a plurality of panels defining an interior compartment of the bag, and a mouth portion for accessing the interior compartment of the bag. The closure system is implemented in two opposing panels of the plurality of panels. Specifically, each one of the two opposing panels further includes a first portion defining a handle and a second portion including an aperture. The first portion of each opposing panel is positioned at a top edge of the panel proximate to the mouth portion, and the second portion of each panel is positioned adjacent to and below the first portion. The handles of the two opposing panels are configured to be drawn together, inserted successively through each of the apertures, and then cinched in order to close the mouth portion of the bag.

### FIELD OF THE INVENTION

The present invention relates to the field of flexible bags in general and, more particularly, to flexible bags that have a cinch, tie or other closure system provided for closing the bag after filling.

### BACKGROUND OF THE INVENTION

Flexible bags are made in a great number of sizes and configurations for a variety of application. For example, small-sized plastic bags are widely used for packing food and packaging other small items, medium-sized paper and plastic bags are used for grocery shopping and other retail merchandise applications, and large-sized plastic bags are widely used to contain and carry garbage or trash. Extremely large-sized plastic bags are termed flexible intermediate bulk containers (FIBCs, or “super sacks”), and have been used for example to transport large volumes of raw materials required for commercial building.

Paper and plastic films are particularly cost-effective materials for use in single-use bag applications. In applications where the bags may be used more than once (for example, grocery shopping), materials such as burlap, woven polyethylene and non-woven polyethylene may be used for their greater tear resistance and wear quality.

In single-use garbage bags, plastic film bags have become a ubiquitous component of everyday life, providing an easy and inexpensive means for gathering and securing garbage for disposal. Commonly, a soft, flexible plastic such as LDPE (Low Density Polyethylene) or, for strength, LLDPE (Linear Low Density Polyethylene) is extruded, for example, to form garbage bags for packaging in roll form. HDPE (High Density Polyethylene) is sometimes alternatively used.

Manufacture of plastic film garbage bags is most economically carried out using a blown film process. To begin this process, raw material in the form of small plastic beads (resin) is gravity fed from a top mounted hopper into the barrel of an extruder. Additives such as colorants and UV inhibitors, also in pellet form, may also be mixed into the resin prior to arriving at the hopper.

The mixed material is fed through the feed throat (an opening near the rear of the barrel) and comes into contact with a rotating screw. The rotating screw forces the plastic beads forward into the barrel which is heated to the desired melt temperature of the molten plastic (for example, around 200° C.). In most processes, a heating profile is preferably set for the barrel in which three or more independently controlled heaters gradually increase the temperature of the barrel from the rear (where the plastic enters) to the front. This allows the plastic beads to melt gradually as they are pushed through the barrel and lowers the risk of overheating, which may cause degradation in the polymer. Extra heat is contributed by the intense pressure and friction taking place inside the extruder barrel. Typically, cooling fans are used to keep the temperature below a set value.

At the front of the barrel, the molten plastic leaves the screw and travels through a screen pack to remove any contaminants that may have entered the melt. The screens are typically reinforced by a breaker plate (a thick metal puck with many holes drilled through it) since the pressure at this point can exceed 5000 psi (34 MPa). The screen pack/breaker plate assembly also serves to create back pressure in the barrel, which is necessary for uniform melting and proper mixing of the polymer.

After passing through the breaker plate, the molten plastic enters a die. The die is an upright cylinder with a circular opening similar to a pipe die. The diameter can be a few centimeters to more than three meters across. The molten plastic is pulled upwards from the die by a pair of nip rolls high above the die (4 meters to 20 meters or more depending on the amount of cooling required). In the center of the die is an air outlet from which compressed air can be forced into the center of the extruded circular profile, creating a bubble. This expands the extruded circular cross section by some ratio (a multiple of the die diameter), thus decreasing the wall thickness. This ratio, called the “blow-up ratio” can be from a few percent to 200 percent of the original diameter. The nip rolls flatten the bubble into a double layer of film, having a width (called the “layflat”) that is equal to half of the circumference of the bubble. This flattened film can then be spooled or printed on, cut into shapes, and heat sealed.

In order to form the plastic film bags, the flattened film is fed though heat rolls that periodically apply a thermal bond across the sheet to form a bottom portion of the bag, and then through cutting rolls or dies that that cut the sheet adjacent to each thermal bond to separate the bag from the extrusion and to form the mouth of the next bag.

Conventional plastic film garbage bags can be classified into two types: flat-mouth bags, and vest- or ear-style bags. For each type, after filling the bag, the mouth of the bag may be closed by tying portions of the bag adjacent to the mouth into a knot. More specifically, in the case of the flat-mouth bag, bag material along opposite rim sides of the mouth is gripped to form two handles or strips, which are tied together to form the knot. However, as described in U.S. Pat. No. 5,980,109, which is incorporated by reference herein in its entirety, as a result of the loss of the bag material used to form the handles, the utilization ratio (i.e., portion of the volume of the bag which may be filled with garbage) of a bag sealed in this manner is limited to 65%-80%. If the garbage bag happens to be over-filled, it becomes difficult to tie the knot. Even if tied, an insufficient amount of material may be used to form the strips, such that the bag may become easily untied.

Vest-style bags overcome this deficiency by providing additional material (i.e., the “shoulder” portions or “ears” of the vest) to form the tying strips. However, vest-style bags may not be as conveniently and inexpensively formed as flat-mouth bags in continuous bag rolls, and it may still be difficult to tie the ears of the vest to form a knot if the bag has been overfilled.

In order to overcome these shortcomings, several additional types of garbage bags have been developed. FIGS. 1 and 2 depict a bag 10 with a flat mouth 12 and a tie-wire 11 pre-set (for example, adhesively) on the outside of the bag near the mouth 12. As illustrated in FIG. 2, the tie-wire 11 can be removed from the outside of the bag 10 without damaging the bag 10, and then tied around the mouth 12 of the bag 10 to close the bag 10. However, the tie-wire 11 may be difficult for a single user to tie tightly around the mouth 12 of the bag 10, and may be difficult to find or may be lost at the time at which the bag 10 is to be closed. In addition, setting the tie-wire 11 onto the bag 10 adds production cost and difficulty.

Alternatively, as shown in FIG. 3, a bag 13 may be formed in which an endless tie-wire 16 is placed into a folded wire channel 14 at the rim of the mouth 17 of the bag 13. In order to close the bag 13, the endless tie-wire 16 is pulled from the opening 15 of the wire channel 14 to and tied together to close the mouth 12. While the endless tie-wire 16 may be easier to manipulate than the tie-wire 11, adding the tie-wire 16 and channel 14 to the bag 13 also increases production cost and difficulty. For example, the bag 13 cannot be prepared using a blown film process as described above, but must rather be prepared by forming the channel 14 on a flat plastic sheet, adding with the tie-wire 16 to the channel, folding the sheet over and forming thermal bonds along a bottom edge, edges of the channel and a side edge of the folded sheet in order to form the bag 13.

Referring to FIGS. 4 and 5, a third type of garbage bag as disclosed by U.S. Pat. No. 5,980,109 is shown, in which a tie-strip 3 is formed from material at an edge of a plastic bag 4. A thermal bond line 1 extends along a portion of a lateral edge of the bag 4 between a lower point spaced from a bottom edge of the bag 4) and an upper point spaced from mouth of the bag 4 to define a thermal bond strip of the bag 4. A tear line 2, which is a rupturable separation line, extends along and within the thermal bond strip and separates it into two portions. By tearing the bag 4 along the tear line 2, a tie-strip 3 is formed. A second thermal bond line 5 is preferably formed along an outer edge of the tear line 2 to add strength to the tie-strip 3. While this third type of garbage bag provides the advantage of providing a closure formed from just from the extruded material of the bag 4, it still suffers the disadvantage of requiring a user to separate the tie-strip 3 from the bag 4 and apply the tie-strip 3 to the mouth of the bag in order to close the bag. As in the case of the bag illustrated in FIG. 1, the tie-strip 3 may be difficult for a single user to tie tightly around the mouth of the bag 4 in order to achieve an effective closure of the bag.

Referring to FIGS. 6A-6D, a fourth type of garbage bag is shown as disclosed by U.S. Pat. No. 4,778,283 is shown. U.S. Pat. No. 4,778,283 is hereby incorporated by reference herein in its entirety.

In FIGS. 6A-6D, a draw band bag 20 includes a front panel 21 and a rear panel 22 formed from a polyethylene tube. Opposing sides are cut from the tube in a perpendicular direction. The tube is slit along a top 23 to form an opening. Holes 24 are punched in both of the panels 21 and 22 of the bag at a predetermined distance from the top 23. A draw tape or band 25 is positioned on the outer surface of panel 21 parallel to the top 23 and over the holes 24. The ends of the draw band 25 are secured to the opposite sides of the bag 20 when side heat seals 26 and 27 are made. A bottom 28 of the bag 20 is formed by the fold joining the front and back panels 21 and 22.

As is further disclosed in U.S. Pat. No. 4,778,283, the draw tape 25 may alternatively be produced by folding the panels 21 and 22 over one side of the bag 20 and securing the fold to the opposite sides of the bag 20 when side heat seals 26 and 27 are made. Once the gold has been secured, an outer one of the panels 21 and 22 is slit at the fold in order to create the open top 23. The other one of the panels 21 and 22 is perforated, so that the folded-over portion of the panels 21 and 22 can later be separated to form the draw band 25.

Closure of the bag 20 is effected by inserting the middle of the band 25 as a loop through the holes 24 in both panels 21 and 22, and pulling in the top corners of the bag 20 to the holes 14 at the center of the panels. As shown in FIG. 6D, for example, the draw tape 25 can then be used to make a half hitch around the top 23 of the bag and pulled tight. Although the bag of FIGS. 6A-6D provides an integral closure systems, like the endless tie-wire bag of FIG. 3, it is relatively costly and difficult to produce.

Therefore, it would be advantageous to provide a plastic garbage bag having an inexpensive, integral closure system which can be easily manufactured and used for effectively closing the bag.

### SUMMARY OF THE INVENTION

The present invention is directed to an integral closure system for a flexible bag which may be used in any of a variety of applications (for example, in merchandise bags and in garbage or trash bags). The flexible bag includes a plurality of panels defining an interior compartment of the bag, and a mouth portion for accessing the interior compartment of the bag. In one embodiment of the invention, the closure system is implemented in two opposing panels among a plurality of panels of the bag.

Specifically, each one of the two opposing panels includes a first portion integrally defining a handle, and a second portion including an aperture. The first portion of each opposing panel is positioned near a top edge of the panel proximate to the mouth portion, and the second portion of each panel is positioned adjacent to and below the first portion. The handles of the two opposing panels are configured to be drawn together, inserted from an interior compartment side successively through each of the apertures, and then cinched in order to close the mouth portion of the bag.

The handles are preferably formed by cut lines applied at the border between the first and second portions of the opposing panels. The cut lines extend across a width direction of the panels, and have opposing ends that are spaced inwardly apart from side edges of the opposing panels. The cut lines are preferably formed as a series of spaced-apart perforations.

The apertures are preferably centered between the side edges of the panels, and are preferably circular or oval in shape. The apertures may be formed by cutting spaced-apart perforations into the second portion that conform to perimeters of the apertures, and then pushing out interior panel material within the cut lines to form the apertures.

As compared to prior art closure systems, the present invention requires no separate components to be added to or formed on the panels of the flexible bag, and results in a closure system that is integrated with the bag so that it cannot be misplaced or lost. The present invention is also cost-effective to produce as compared to prior art closure systems.

### BRIEF DESCRIPTION OF THE DRAWINGS

The inventions will become more readily apparent from the Detailed Descriptions of the Invention, which proceeds with reference to the drawings, in which:

FIG. 1 shows a conventional flat-mouth garbage bag having a separate tie-wire pre-set on an exterior surface of the bag;

FIG. 2 shows the bag in the bag of FIG. 1 in a closed state;

FIG. 3 shows another conventional flat-mouth garbage bag incorporating a tie-wire in a folded wire channel provided at the rim of the mouth of the bag;

FIG. 4 shows another conventional flat-mouth garbage bag incorporating a tie-strip formed from at an edge of the bag;

FIG. 5 shows the bag of FIG. 4 with the tie-strip in a detached state;

FIGS. 6A-6D show another conventional flat-mouth garbage bag having a draw band and an opening through which the draw band is inserted for closing the bag;

FIG. 7 shows a garbage bag including a closure system according to an embodiment of the present invention;

FIG. 8 provides a process flow diagram depicting a method for operating the closure system of FIG. 6; and

FIGS. 9A-9D illustrate steps in the method depicted in FIG. 8;

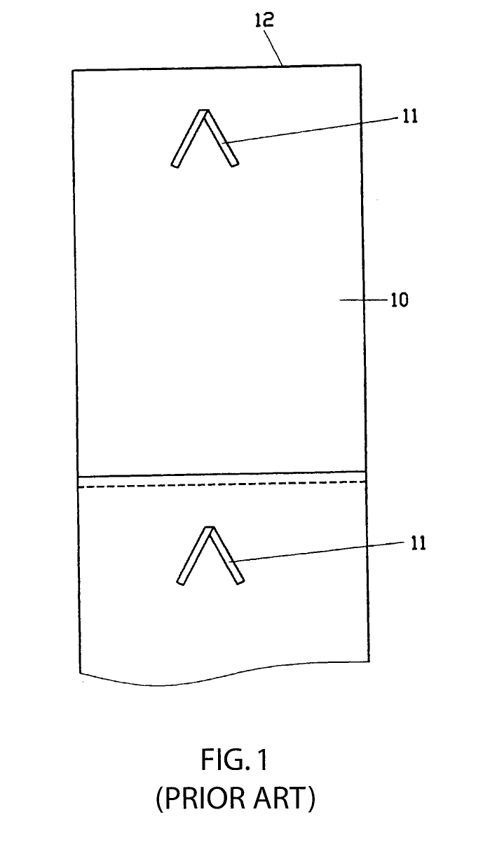

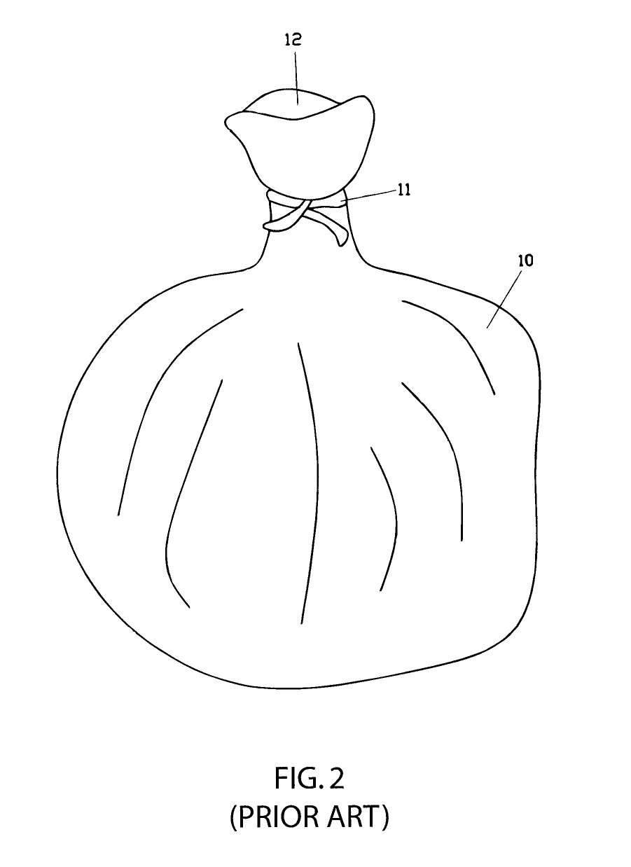

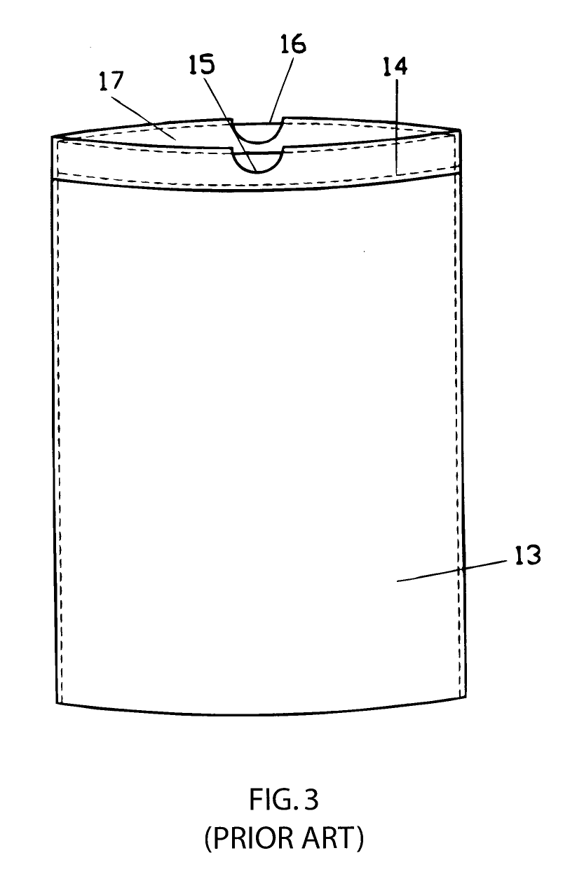

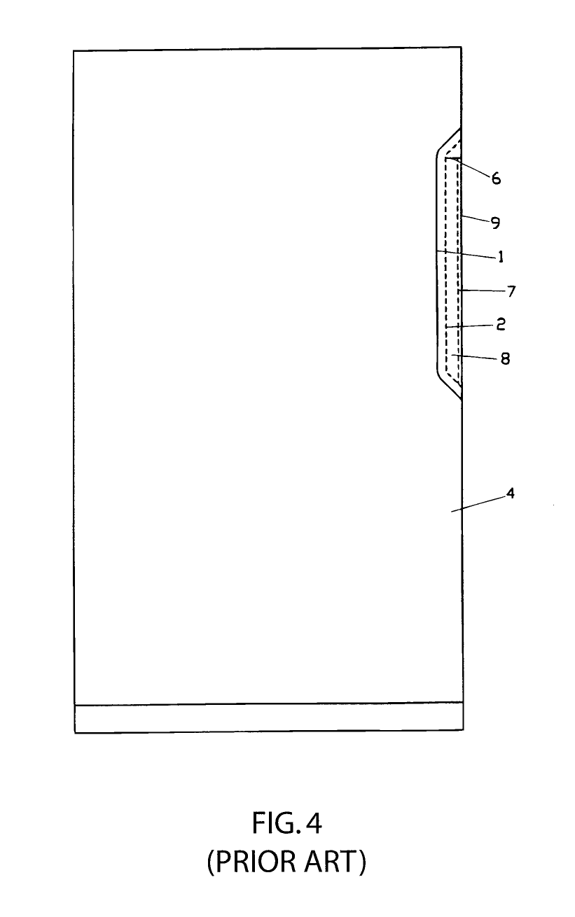

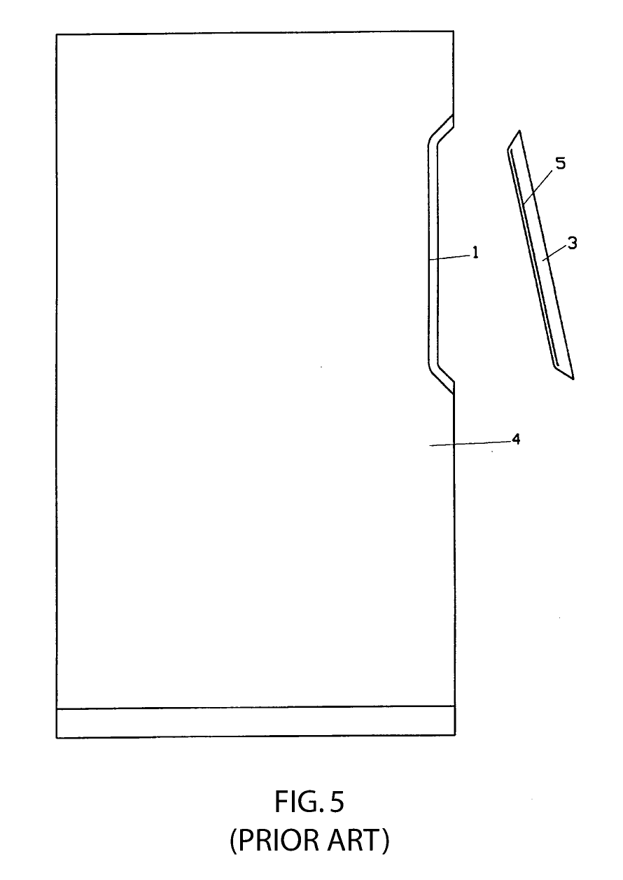

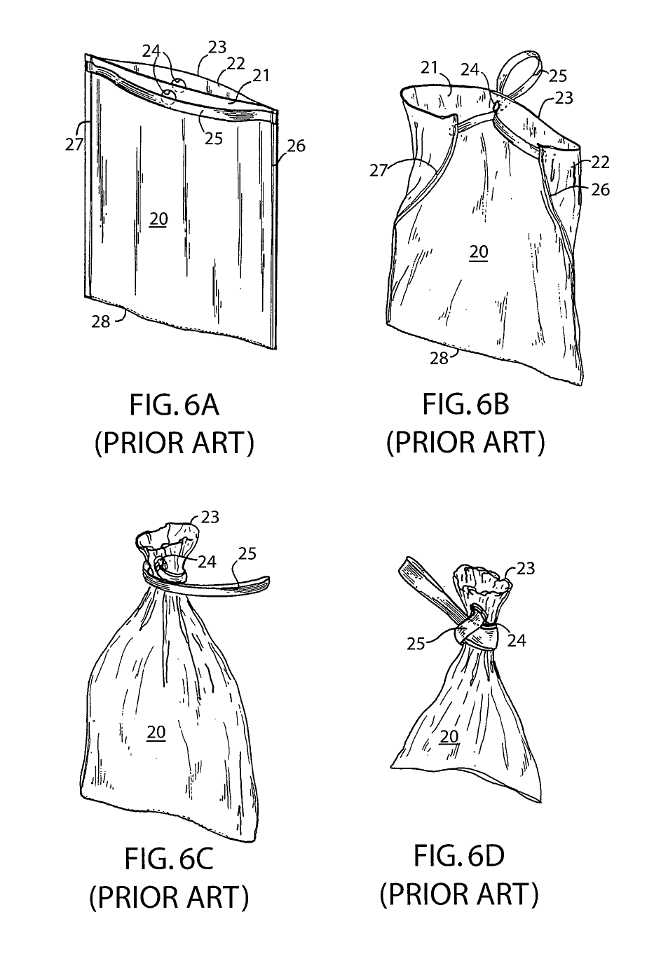

### DETAILED DESCRIPTION OF THE INVENTION

The present invention is directed to an improved closure system for flexible bags, including for example conventional blown film garbage or trash bags (for example, comprising one of LDPE, LLDPE and HDPE) and merchandise bags (for example, comprising one of burlap, woven polyethylene and non-woven polyethylene). The inventive system requires no additional material components be added to the bags, and forms the closure system integrally with the bag. As a result, components of the closure system cannot be misplaced or lost during use of the bag. Moreover, the closure system is cost-effective to produce, and is easily operated by a single user to effectively close the bag without significantly compromising the utilization ratio of the bag.

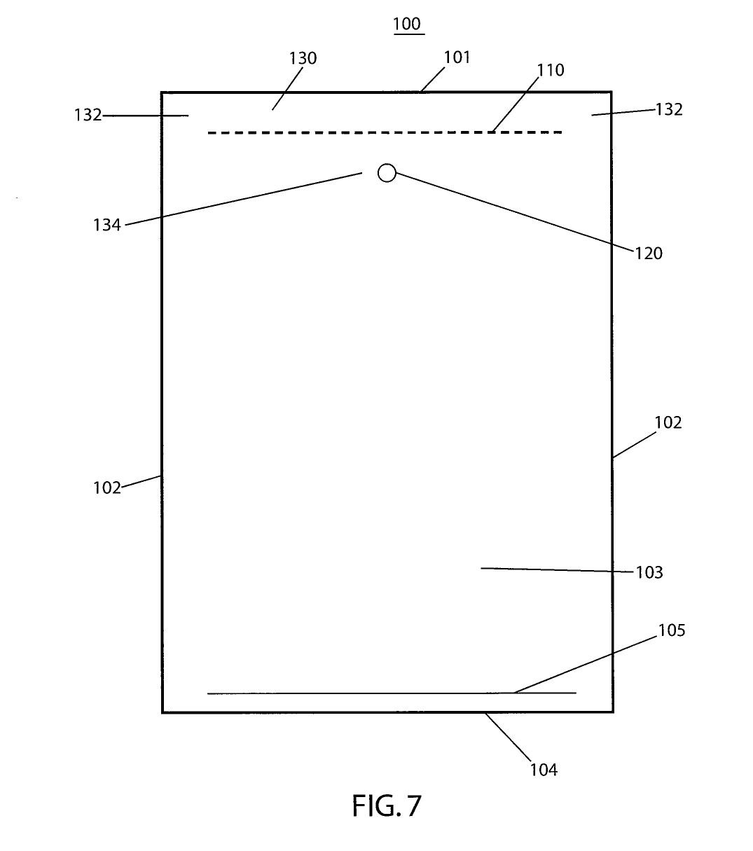

FIG. 7 depicts a flexible bag 100 having a closure system according to an embodiment of the present invention. While the bag 100 is depicted as a conventional, flat-mouth extruded plastic bag (for example, comprising one of LDPE, LLDPE and HDPE), a skilled artisan will readily understand that the bag 100 may alternatively be formed from a folded plastic sheet, may have a vest-style mouth, and/or may be formed from a reinforced paper, woven polyethylene, non-woven polyethylene or impregnated cloth material rather than as a blown-film plastic extrusion. The bag 100 may be used in a variety of applications (for example, as a grocery bag or as a bag for carrying other merchandise).

In FIG. 7, the flexible bag 100 is depicted in a “flattened” state, with overlapping panels 103 that that coextensively define a mouth 101, side edges 102 and a bottom edge 104. Because they are formed in a continuous extrusion and then flattened, the overlapping panels 103 are seamlessly joined at the side edges 102. A bottom edge 104 is preferably formed by cutting the continuous extrusion, and then sealed in a fully closed state by a thermal bond 105.

The panels 103 are each provided with perforations 110 and apertures 120. The perforations 110 preferably extend in a line below and parallel to the mouth 101 of the flat-mouth bag 100, terminating inwardly from side edges 102 of the bag 100. The apertures 120 are provided below the perforations 110, and are preferably centered between the side edges 102.

In accordance with the present invention, the perforations 110 and apertures 120 may be provided at various positions on the panels 103. In a preferred embodiment, the panels are configured to have a length of about 32.5 inches along the sides 102 and a width of about 23.5 inches along the bottom edge 103 and mouth 101. In this preferred embodiment, the perforations 110 are offset by about 2 inches below the mouth 101, and terminate inwardly about 2 inches away from each side edge 102. The apertures 120 preferably have a diameter of about one inch, and are preferably centered between the side edges 102 and about 2 inches below the perforations 110.

The perforations 110 and apertures 120 may be readily produced, for example, by passing the flexible bag 100 in its flattened state through conventional cutting rollers having elements configured to cut the continuous extrusion to form the mouth 101, as well as elements configured to cut the perforations 110 and apertures 120. The cutting and perforating elements may be provided on a single roller, or on a series of rollers. By passing the bag 100 through the cutting rollers in its flattened state, the perforations 110 and apertures 120 may be simultaneously cut into both panels 103.

As an alternative to the blown-film plastic bag, and as previously noted, the bag 100 may be formed from a folded sheet or two overlaid sheets that are joined along open seams (for example, by thermal bonding, adhesive and/or stitching), and/or reinforced paper, woven polyethylene, non-woven polyethylene, burlap and or impregnated cloth material. With any of these alternatives, the perforations 110 and apertures 120 may preferably still be formed in the bag 100 in the above-described manner.

In some applications, one or more of a region surrounding the perforations 110 and/or the apertures 120 may receive additional reinforcement for extending the useful life of the bag 100. Suitable reinforcement may include, for example, the application of an adhesive in the regions surrounding the perforations 110 and/or the apertures 120, the application of stitching (for example, to prevent unraveling of a woven bag material, or the application of one or more additional material layers surrounding the perforations 110 and/or the apertures 120 (for example, adhesively, by thermal bonding or by stitching). The additional material layers may be formed form additional layers of the material of the bag 100, or by other materials having more desirable reinforcement properties (for example, using a heavier gauge non-blown film plastic to reinforce the perforations 110 and/or the apertures 120 of a blown film plastic bag.

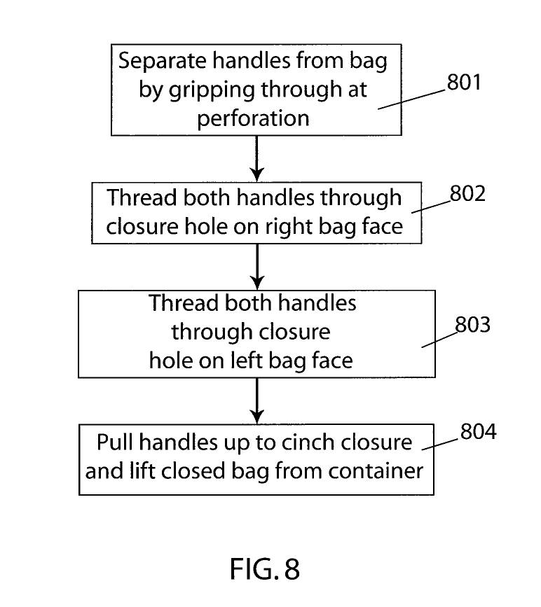

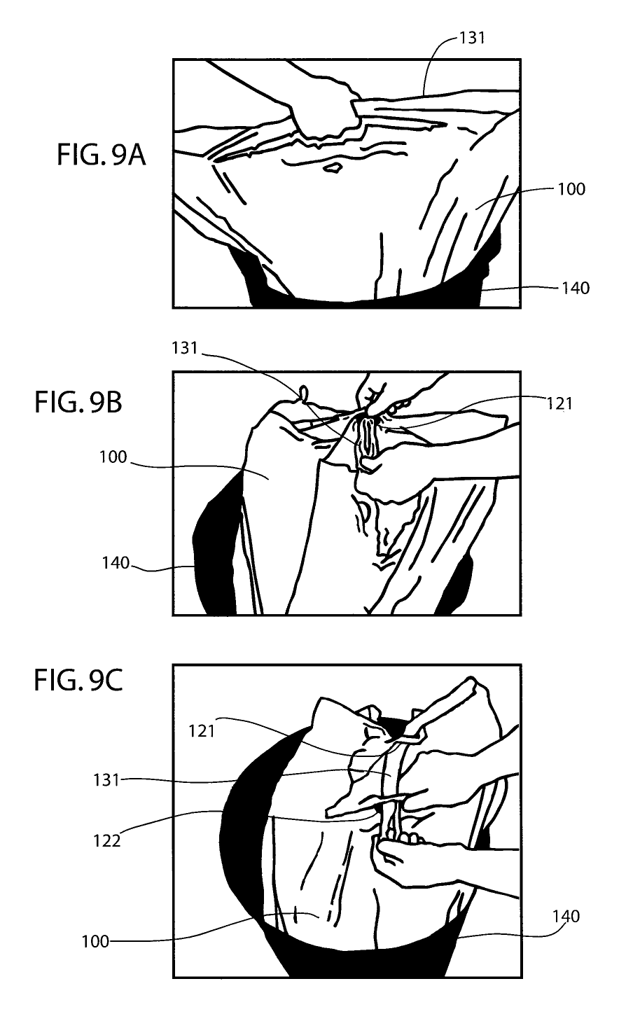

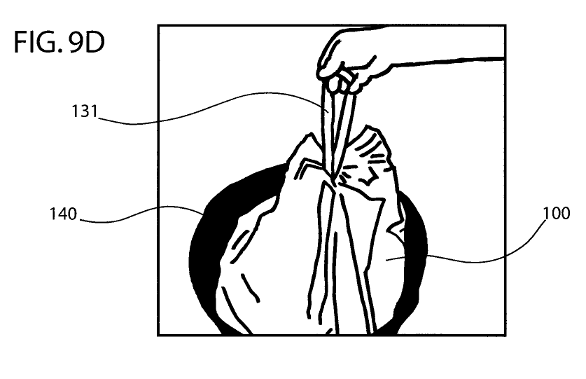

FIG. 8 presents a process flow diagram depicting a method for operating the closure system of FIG. 7. FIGS. 9A-9D further illustrate the steps of FIG. 7.

At step 801 of FIG. 8, a user begins the closure process by grabbing bag material 130 between the mouth 101 and perforations 110 of the flexible bag 100 with one hand, and pressing the fingertips of his or her hand through the perforations 110 in order to separate the material 130 from the rest of the material of the panels 103 along the perforations 110. As further illustrated for example in FIG. 9A, the separated material 130 from the panels 103 forms two handles 131 of the bag 100.

At step 802 of FIG. 8, the user proceeds to thread both handles 131 through one of the apertures 120 in the panels 103 (for example, an aperture 121 in a panel 103 defining a right bag face, as illustrated in FIG. 9B). As the apertures 120 are preferably formed by perforations in the panels 103 along perimeters of the apertures 120, the user at step 702 may be required to press his or her fingertips through material of the panels 103 within each perimeter in order to separate and remove this material from the panels 103 prior to the threading step.

Next, at step 803, the user threads both handles 131 through the other one of the apertures 120 (for example, an aperture 122 in another panel 103 defining a left bag face, as illustrated in FIG. 9C). According to the user's preference, the handles may be threaded from the exterior of the bag 100 along a single direction through both apertures 121, 122, or may be threaded from the interior of the bag first in a direction through one of the apertures 121, 122 and then in an opposing direction over the top of the bag and through the other of the apertures 121, 122.

Finally, at step 804, the user pulls upwardly on both handles 131 in order to draw upper side regions 132 of the panels 103 (see, e.g., FIGS. 7 and 9D) and middle portions 134 of the panels in the vicinity of apertures 121, 122 together to close the mouth 101.

The pathway taken by the handles 131 through the apertures 121, 122 upon pulling upwardly on the handles 121 causes a cinching effect, which assists in maintaining the mouth 101 in its closed position when the handles 131 as extended by the upward pulling are ultimately released by the user. The extended handles can then be easily employed, for example, by the user to lift the bag 100 out of a receptacle 140 in order to then carry and dispose of the bag 100.

Those skilled in the art will readily recognize additional numerous adaptations and modifications which can be made to the present invention which fall within the scope of the present invention as defined in the claims. For example, the invention may be further modified in one of more of the following ways:
by positioning the apertures at a position other than centered between side edges of the bag (for example, in the vicinity of the side edges of the bag);
by adding additional apertures for further threading of the handles;
by adding additional perforations defining additional handle pairs;
by configuring the perforations along other than a straight line (for example, curving downwardly in the vicinity of the side edges for adding strength to the handles at their points of connection to the bag;
by configuring the apertures with other than a circular shape (for example, configuring the apertures in an elliptical shape); and
by adding reinforcements surrounding the apertures and or along the handles for added strength.

It is intended that the scope of the present invention include all foreseeable equivalents to the elements and structures as described with reference to FIGS. 7-9D. Accordingly, the invention is to be limited only by the scope of the claims and their equivalents.

We claim:

1. A flexible bag, comprising:
a plurality of panels defining an interior compartment of the bag and including two opposing panels; and
a mouth portion for accessing the interior compartment of the bag,
the two opposing panels each further including:
a first portion defining a handle, the first portion being positioned at a top edge of the panel proximate to the mouth portion, and
a second portion including an aperture, the second portion being positioned adjacent to and below the first portion.

2. The flexible bag of claim 1, wherein the handles of the two opposing panels are configured to be inserted together through each of the apertures and cinched in order to close the mouth portion of the bag.

3. The flexible bag of claim 1, wherein each first portion further comprises a cut line positioned at a boundary between the first portion and the adjacent second portion for defining the handle.

4. The flexible bag of claim 3, wherein opposing ends of each cut line are positioned away from side edges of the respective first portion.

5. The flexible bag of claim 3, wherein each cut line is formed as a series of spaced-apart perforations.

6. The flexible bag of claim 1, wherein the aperture in each opposing panel is centered between side edges of the panel.

7. The flexible bag of claim 1, wherein the plurality of panels are formed as a blown-film plastic extrusion, the plastic being selected from the group consisting of low density polyethylene (LDPE), linear low density polyethylene (LLDPE) and high density polyethylene (HDPE).

8. The flexible bag of claim 1, wherein the flexible bag is a trash bag.

9. The flexible bag of claim 1, wherein the plurality of panels are formed from one or more woven polyethylene sheets.

10. The flexible bag of claim 1, wherein the flexible bag is a merchandise bag.

11. The flexible bag of claim 1, wherein the merchandise bag is a grocery bag.

12. A flexible bag, comprising:
opposing panels each having a top edge, a bottom edge and side edges, each one of the opposing panels including:
at least one cut line extending below the top edge and between the side edges in an upper region of the panel, each cut line terminating at opposing ends positioned away from the side edges of the panel, and
an aperture positioned downwardly from the at least one cut line.

13. The flexible bag of claim 12, wherein the at least one cut line in each of the opposing panels is formed as a series of spaced-apart perforations in the panel.

14. The flexible bag of claim 12, wherein each of the opposing panels comprises a single cut line in the upper region of the panel.

15. The flexible bag of claim 12, wherein the aperture in each of the opposing panels is centered between the side edges of the panel.

16. The flexible bag of claim 12, wherein:
each of the opposing panels has a width of about 23.5 inches and a length of about 32.5 inches.

17. The flexible bag of claim 16, wherein:
the aperture in each of the opposing panels is a circular aperture, and
a center point of the aperture is positioned downwardly from the at least one cut line by about two inches.

18. The flexible bag of claim 17, wherein the circular aperture has a diameter of about one inch.

19. The flexible bag of claim 16, wherein:
the at least one cut line in each opposing panel is spaced about two inches downwardly from the top edge of the panel, and
the opposing ends of the at least one cut line are each spaced about two inches inwardly from a respective side edge of the panel.

20. The flexible bag of claim 12, wherein the opposing panels are formed in a blown-film plastic extrusion, the plastic being selected from the group consisting of low density polyethylene (LDPE), linear low density polyethylene (LLDPE) and high density polyethylene (HDPE).

21. The flexible bag of claim 12, wherein the flexible bag is a trash bag.

22. The flexible bag of claim 12, wherein the opposing panels are formed from one or more woven polyethylene sheets.

23. The flexible bag of claim 12, wherein the flexible bag is a merchandise bag.

24. A method for forming a closure for a flexible bag, the method comprising the steps of:
flattening the bag to form two overlapping panels, the overlapping panels defining a top edge, a bottom edge and side edges of the bag,
forming at least one cut line in each overlapping panel, the cut lines each extending below the top edge and between the side edges in an upper region of the bag and terminating at opposing ends positioned away from the side edges of the panel, and
forming an aperture in each overlapping panel, wherein each aperture is positioned downwardly from the at least one cut line.

25. The method of claim 24, wherein the step of forming the at least one cut line in each overlapping panel further includes the step of:
cutting a series of spaced-apart perforations into the panel to form the at least one cut line.

26. The method of claim 24, wherein the step of forming the aperture in each overlapping panel further includes the step of:
cutting a series of spaced-apart perforations into the panel to form a perimeter of the aperture.

27. The method of claim 24, further comprising the step of forming the bag prior to the flattening step as a blown-film plastic extrusion, the plastic being selected from the group consisting of low density polyethylene (LDPE), linear low density polyethylene (LLDPE) and high density polyethylene (HDPE).
